(19) United States
(12) Patent Application Publication
(10) Pub. No.: US 2006/0225913 A1
(43) Pub. Date: Oct. 12, 2006

(54) Cast-resin insulator having reduced leakage path formation

(75) Inventors: Markus Hornbach, Hammersbach (DE); Hans-Joachim Muller, Rosbach (DE)

Correspondence Address: MORRISON & FOERSTER LLP, 1650 TYSONS BOULEVARD, SUITE 300, MCLEAN, VA, 22102, US

(73) Assignee: Siemens Aktiengesellschaft, Munchen (DE)

(21) Appl. No.: 11/101,636

(22) Filed: Apr. 8, 2005

(51) Int. Cl. H01R 4/70

(52) U.S. Cl. 174/138 F

(57) ABSTRACT

In order to provide an insulating component (1) for the purpose of holding or guiding through an electrical conductor in switchgear assemblies in medium-voltage technology, the insulating component (1) having a nonconductive, rigid insulating body (3) having rigid outer ribs (6) for the purpose of extending the leakage path, which is also suitable for an application outdoors and is likewise cost-effective, it is proposed to apply an outer layer (7) made of oliophobic and/or hydrophobic material.

The invention relates to a component for use in switchgear assemblies in medium-voltage technology having an electrically nonconductive insulating body made of a cast resin.

The invention further relates to a method for producing a component which has an electrically nonconductive insulating body, in the case of which the insulating body is produced from a cast resin in an injection-molding process.

Such a component and such a method are already known from the common prior art. It is thus conventional in medium-voltage technology to electrically insulate conductors or other electrical elements, which have a medium-voltage potential of between 1 kV and 50 kV applied to them, with respect to their surroundings. For this purpose, an electrically nonconductive insulating body is generally used in which the respective element is embedded, for example. Components of this type comprise, for example, post insulators, with the aid of which the conductors which have a high-voltage potential applied to them are held on the housing wall of a switchgear assembly. A bushing also represents a generic component with the aid of which a conductor which has a high-voltage potential applied to it is guided through a housing wall lying at ground potential.

The insulating body of the previously known component is made of, for reasons of cost, a cast resin, in particular based on biphenol. When used outdoors, however, a contamination layer covering often results, for example owing to moisture condensation. Leakage currents may flow over these contamination layers which cover the surface of the insulating body in a more or less cohesive manner, and these leakage currents lead to more or less severely pronounced leakage path formations, depending on the quality of the cast resin of the insulating body. In particular in the case of cast resin based on biphenol, leakage path formation occurs early, and this makes its use outdoors more difficult. Owing to the erosion produced in the case of leakage path formation, the surface of the insulating body is damaged, and the resin system lying underneath is decomposed. In the decomposition process, in turn carbon compounds result which increase the surface conductivity and as a result accelerate the progress of erosion. After a corresponding amount of time, this leads to total failure of this component.

It is likewise known from the common prior art to provide insulating bodies with a silicone covering, flexible outer ribs being integrally formed on the elastic silicone covering. The use of such composite material components has until now not been used in the medium-voltage range. Also, when used in gas-insulated switchgear assemblies, difficulties result as regards the gas-tightness of such composite materials.

It has also been proposed to manufacture the insulating body from a cast resin based on cycloaliphatic compounds. Cast-resin systems based on cycloaliphatic compounds have improved properties as regards leakage path formation. Damage to the cycloaliphatic cast resin on the surface does not lead to higher leakage currents. In addition, the insulating material has, as such, improved erosion properties. The use of cycloaliphatic cast resins, however, is cost-intensive.

The object of the present invention is therefore to provide a component of the type mentioned initially which is suitable for use outdoors and at the same time is cost-effective.

The object of the present invention is also to provide a method of the type mentioned initially which makes possible production of a cost-effective component which can be used outdoors.

The invention achieves this object on the basis of the component mentioned initially by an outer layer made of a hydrophobic coating which is applied to the insulating body.

The invention achieves this object on the basis of the method mentioned initially by a layer made of a hydrophobic coating being applied to the insulating body.

In accordance with the present invention, the tendency of the insulating body towards leakage path formation is reduced by an outer layer made of a hydrophobic coating being applied to the insulating body. The outer layer, which is applied, for example, after curing of the insulating body, prevents formation of a continuous or cohesive contamination coating, for example by means of moisture condensation on the insulating body, owing to its hydrophobic properties. This suppresses the leakage path formation and erosion of the insulating body. In this case it is possible to manufacture the insulating body from any desired cast resin which is, for example, cost-effective, without by this means its use possibilities, for example outdoors, being restricted. In the context of the invention, it is also possible to manufacture components for applications indoors or outdoors largely using the same production method. It is no longer necessary according to the invention to install a separate manufacturing sequence for indoor and outdoor applications. In addition, savings are made on costs for testing the insulating body, since said insulating body is no longer made of different materials, whose selection is dependent on the application site. The application of the hydrophobic coating takes place, for example, by means of spraying, by means of dipping the insulating body in a bath of the liquid coating material, by brushing on or the like.

The component according to the invention is, for example, a post insulator and serves the purpose of holding conductors which have a high-voltage potential applied to them on the housing wall of a medium-voltage switchgear assembly at ground potential. As a deviation from this, the component is a bushing, with which a high-voltage conductor is passed through the wall of a switchgear assembly. The switchgear assembly may be either a gas-insulated switchgear assembly or an air-insulated switchgear assembly. Further exemplary embodiments of the component according to the invention are current transformers, voltage transformers, cable female connectors or the like.

In accordance with an expedient development, the component according to the invention has an insulating body on which, for example, outer ribs are integrally formed. The insulating body and the outer ribs are advantageously of rigid design. The component according to the invention therefore differs from previously known components in the case of which an elastic covering made of EPMD, rubber, silicone or the like is subsequently pushed over onto a rigid insulator.

According to the invention, the outer layer is made of a hydrophobic coating. Hydrophobic coatings are more cost-effective than, for example, silicone and are therefore preferred in the context of the present invention for the purpose of forming the outer layer. The hydrophobic coating is, for example, transparent. As a deviation from this, the coating has an intrinsic color which imparts a characteristic color to the insulating body.

In accordance with one preferred development of the invention, the insulating body is made of biphenol resin. Biphenol resin is used owing to its excellent insulation properties and also for cost reasons. The biphenol resin coating makes it possible according to the invention to use such insulating components, which have up until now only been able to be used in enclosed spaces, even for an application outdoors. For both application sectors, only a single manufacturing sequence is required, the insulating body of the components provided for an outdoors application merely being coated subsequently.

In one preferred development of the method according to the invention, a cast resin based on biphenol is used.

Further expedient refinements and advantages of the invention are the subject matter of the description below of exemplary embodiments of the invention with reference to the figures in the drawing, in which identical reference numerals refer to functionally identical parts, and in which:

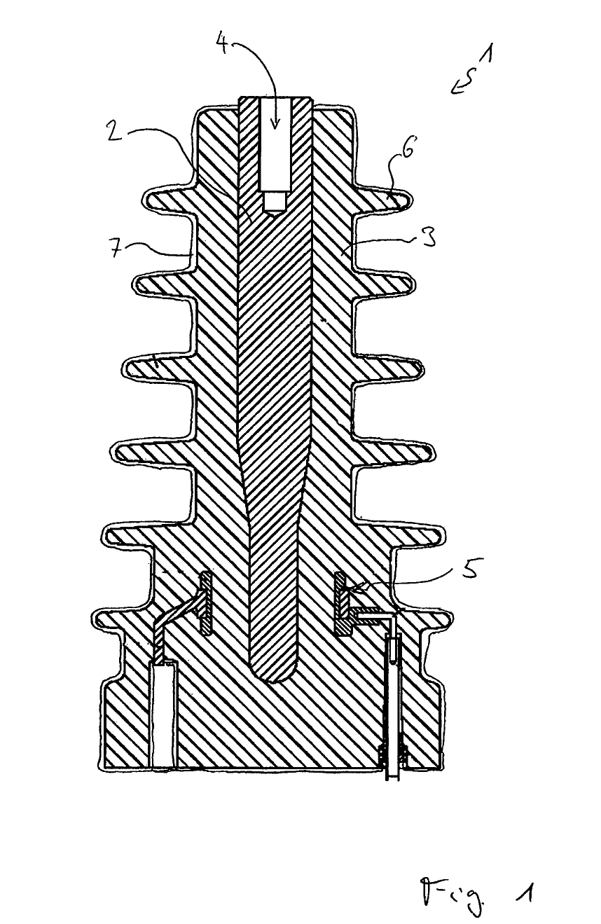

FIG. 1 shows a cross-sectional view of a post insulator as an exemplary embodiment of the component according to the invention, and

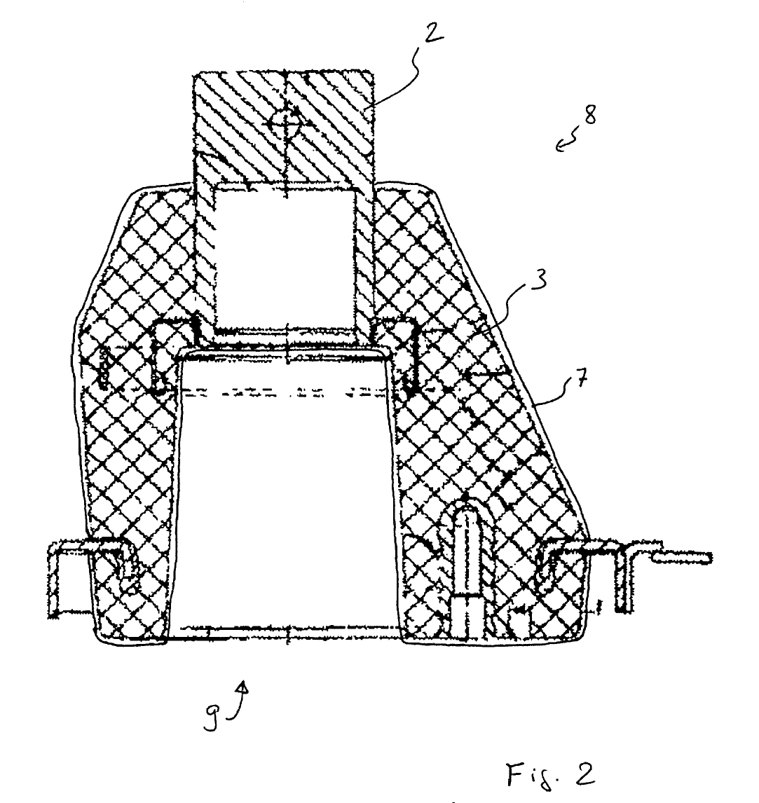

FIG. 2 shows a cross-sectional view of a female connector as a further exemplary embodiment of the component according to the invention.

FIG. 1 shows a cross-sectional view of a post insulator 1 as an exemplary embodiment of the component according to the invention which is equipped for the purpose of bearing a high-voltage conductor or a so-called busbar on a housing wall (not shown in the figures) of a medium-voltage switchgear assembly at ground potential. The post insulator 1 has a conductor section 2 as the electrically conductive element which is almost completely embedded in an insulating body 3. At its end which protrudes out of the insulating body 3, the conductor section 2 is provided with a recess 4 in which an internal thread is provided and which serves the purpose of fixing the high-voltage conductor. The conductor section 2 thus likewise lies at a high-voltage potential during operation of the component 1, it being possible for said potential to be measured by means of a capacitive coupling electrode 5. In order to increase the length of the leakage path, the insulating body 3 is equipped with outer ribs 6.

The insulating body 3 is made of a biphenol resin in the exemplary embodiment illustrated and is thus of rigid design.

An outer layer 7 made of a hydrophobic coating serves the purpose of suppressing leakage path formation on the outer surface of the insulating body 3. For the purpose of producing the component 1, the conductor section 2 was embedded in the insulating body 3 by means of an injection-molding process. Once the biphenol resin of the insulating body 3 has been cured, the hydrophobic coating is sprayed on, with the result that the outer layer 7 is provided after it has been cured.

FIG. 2 shows a female connector 8 as a component having an insulating body 3 into which the conductor section 2 is introduced. The female connector 8 has an insertion opening 9 for the purpose of inserting an insertion cable (not shown) which makes contact with the conductor section 2 by means of its electrically conductive end in the switched-on position. In the case of an application outdoors, the insulating body 3 is sprayed with an outer layer 7 made of a hydrophobic coating.

Further exemplary embodiments of a component according to the invention are, for example, transformers, current and voltage transformers or the like.

1. A component (1) for use in switchgear assemblies in medium-voltage technology having an electrically nonconductive insulating body (3) made of a cast resin,
characterized by
an outer layer (7) made of a hydrophobic coating which is applied to the insulating body (3).

2. The insulating component (1) as claimed in claim 1,
characterized in that
the cast resin is a biphenol resin.

3. The insulating component (1) as claimed in claim 1,
characterized in that
outer ribs are integrally formed on the insulating body.

4. A method for producing a component (1) which has an electrically nonconductive insulating body (3), in the case of which the insulating body (3) is produced from a cast resin in an injection-molding process,
characterized in that
an outer layer (7) made of a hydrophobic coating is applied to the insulating body (3).

5. The method as claimed in claim 4,
characterized in that
a biphenol resin is used as the cast resin.
